(19) United States
(12) Patent Application Publication
(10) Pub. No.: US 2005/0020843 A1
(43) Pub. Date: Jan. 27, 2005

(54) Process for the transesterification of fat and/or oil by heterogeneous catalysis

(75) Inventors: Siegfried Peter, Uttenreuth (DE); Eckhard Weidner, Bochum (DE); Hans-Peter Neuner, Nurnberg (DE)

Correspondence Address: William H. Logsdon;WEBB ZIESENHEIM LOGSDON ORKIN & HANSON, P.C., 700 Koppers Building, 436 Seventh Avenue, Pittsburgh, PA, 15219-1818, US

(73) Assignee: Siegfried Peter, Uttenreuth (DE)

(21) Appl. No.: 10/887,455

(22) Filed: Jul. 8, 2004

Related U.S. Application Data
(63) Continuation of application No. PCT/EP02/13731, filed on Dec. 4, 2002.

(30) Foreign Application Priority Data
Jan. 9, 2002 (DE) 102 00 528.1

(51) Int. Cl. C07C 51/43

(52) U.S. Cl. 554/176

(57) ABSTRACT

A process for preparing fat and/or oil with a modified distribution of fatty acids in the glycerides by heterogeneously catalysed transesterification, wherein the process comprises reaction of the fat and/or oil of biological origin to be transesterified in the presence of a catalyst consisting of a metal salt of a basic amino acid or an amino acid derivative. The disadvantages of conventional transesterification processes can be overcome by using this catalyst.

The present invention relates to a process for preparing fat and/or oil with a modified distribution of fatty acids by heterogeneously catalysed transesterification.

Transesterification reactions are known per se and they represent a commercially important group of industrial organic reactions. During a transesterification reaction a conversion of one ester into another ester takes place by exchanging the alcohol or acid group. Various types of transesterification reactions, which can be differentiated from each other by the different reactants involved (ester with alcohol, ester with acid, ester with ester), belong to this group of reactions. In one of these types of transesterification reaction, two different esters react with the formation of two new esters (redistribution). Such reactions usually proceed under catalytic conditions in the presence of acids or bases.

The transesterification reaction just mentioned is of interest in particular in connection with the modification of fats and oils, especially fats and oils of biological origin which consist mainly of glycerides (mono-, di- and triglycerides). By redistributing the fatty acids in fats and oils, i.e. by changing the distribution of the fatty acids in the glycerides, the properties of these materials can be altered within a wide range. Thus, for example, the melting point, viscosity and other functional characteristics can be altered in a tailor-made fashion. This process can be applied instead of the classical hardening of fats or other conventional processes for changing the material properties of fats and oils.

Transesterification is used, in particular in the USA, for refining pig fat. Fats with completely new properties can be tailor-made by suitable choice of the transesterification components. Depending on the choice of components, for example the melting point of a mixture of fats after transesterification may be higher or lower than that of the original mixture. Large-scale industrial transesterification processes also take place in the margarine industry to prepare fats with modified properties.

In practice, mainly alkali metals or the methylates thereof are used as catalysts for the transesterification of fats and oils. These are added either in finely divided form or suspended in the fat (0.1 to 0.2 wt. %). Alkali alcoholates (0.1 to 0.3 wt. %) are added in powder form. Within the series K>Na>Li>Mg, potassium has the highest catalytic activity. The fats have to be deacidified (concentration of free fatty acids<0.1 wt. %) and dried before transesterification because free fatty acids, which are always present in fats and oils of biological origin, and water inactivate the catalyst. During reaction, the reaction mixture becomes discoloured, turning orange-brown, and this is evaluated as a first test of the quality of the process. The reaction is generally terminated about 30 min after the occurrence of discoloration. Tests have shown that there is an equilibrium for distribution of the fatty acid molecules in glycerine (K. F. Carlson and J. D. Scott, Inform. 1991, 2(12), 134).

From a chemical engineering point of view, there is a differentiation between uncontrolled (random) and controlled transesterification. In the case of a controlled transesterification, the thermodynamic equilibrium state is used as the starting point and this is deliberately interfered with by crystallising high-melting and sparingly soluble triglycerides which are present or are formed by transesterification and removing these from the equilibrium.

Both processes, i.e. uncontrolled and controlled transesterification, can be performed in batchwise, semi-continuous or fully continuous working procedures. In each case, a drying and degassing process has to precede transesterification so that all moisture is reliably removed. The catalyst has to be dispersed in an extremely fine distribution. This is important if the reaction is to proceed smoothly. The particle size should be less than 50μ. The reaction is generally performed in the temperature range between 70 and 120° C. The reaction time may be less than 1 hour and up to 24 hours. The catalyst is inactivated after completion of the reaction. Inactivation of the catalyst is achieved by adding water, dilute mineral acid or else water and carbon dioxide. During inactivation with water and carbon dioxide, soda is produced in addition to alkali metal soaps (‘Die Umesterung von Fetten’, Gemeinschaftsarbeit der Deutschen Gesellschaft für Fettwissenschaft e.V., Industrieverlag von Hernhaussen KG, Hamburg, 1973).

The equivalent amounts of fatty acid monoesters or alkali metal soaps are produced from alkali metal alcoholates and alkali metals. These are removed during the course of the subsequent refining process, in particular during a deodorising process. They appear in the aqueous part of the condensate and have to be disposed of. Since there is generally a residual amount of soap present in the oil, the mixture is washed and the wash water is separated from the oil by centrifuging. The oil is then dried, bleached and deodorised in a conventional manner.

For uncontrolled transesterification, a reactor which is similar in design to one used for hydrogenation is used. Transesterification with fatty acid esters can be performed either in a batch process, usually in a sealed deacidifying and bleaching apparatus, or in a continuous process. In the event of continuous operation, catalyst and fat are brought into contact in suitable continuous flow equipment.

During controlled transesterification, the fat is cooled, e.g. in a scraped-wall cooler, before transesterification. Then a sufficiently long residence time is required in order to allow the higher-melting glycerides, corresponding to the equilibrium status, to crystallise out. Seeding can facilitate crystallisation. In the case of physically refined oils, there are often problems with regard to the effectiveness of the transesterification process because a low level of free fatty acids has to be present for successful.

An alternative method which is gaining in interest is transesterification using enzymes as catalysts. This process is generally applied in the case of palm-oil based materials such as cocoa butter substitutes and coconut oil.

When transesterifying fats and oils with alkali metals or alkali metal alcoholates, a serious problem occurs. Equivalent amounts of fatty acid monoesters or alkali metal soaps, which appear in the aqueous phase after the final refining process and have to be disposed of, are produced during transesterification.

Therefore the present invention is based on the object to provide a simple and efficient process to prepare fats and/or oils of biological origin with an altered distribution of fatty acids in the glycerides. In particular, it is intended that, as far as possible, no waste waters which have to be disposed of are produced by the new process.

This object is achieved according to the invention by a process in accordance with Claim 1. According to that, surprisingly, metal salts of basic amino acids or amino acid derivatives are suitable as catalysts for the preparation by transesterification of fats and/or oils with an altered distribution of fatty acids in the glycerides. Using the process according to the invention, fats and/or oils of biological origin can be reacted in the presence of these salts, wherein fats and/or oils are produced in which the distribution of fatty acids in the glycerides differs from that in the corresponding starting materials. In the context of this invention, a change in the distribution of fatty acids in the glycerides is understood to include both a change in the direction of a standardised arrangement of fatty acids and also a change in the statistical distribution of the fatty acids. The use of these salts, which are insoluble in the reaction mixture, enables heterogeneously catalysed transesterification reactions to be performed and these are characterised in particular in that no waste waters which have to be disposed of are produced.

The fats and oils used in the process according to the invention have to be deacidified (concentration of free fatty acids <0.1 wt. %) and dewatered before transesterification for good results to be achieved with regard to the rate of the transesterification reaction when using catalysts according to the invention.

In accordance with a preferred embodiment, those catalysts are used whose amino acid component contains a quaternary nitrogen or a guanidino group. Metal salts of arginine or carnitine are particularly preferred.

The metal ions used in the process according to the invention are preferably alkaline earth metal ions, in particular calcium, strontium or barium ions, heavy metal ions, in particular silver, copper, zinc, manganese, iron, nickel or cobalt ions or rare earth metal ions, in particular lanthanum ions. Zinc or lanthanum ions are particularly preferred.

In the context of the invention, very particularly preferably used catalysts are the zinc or lanthanum salts of arginine or carnitine.

Mixtures of catalysts according to the invention may also be used in the process according to the invention.

For the process according to the invention, the catalysts are used in an amount of 5-25 wt. %, preferably 10-20 wt. %. The process may be performed at temperatures of about 60 to 200° C. due to the thermal stability of the catalysts; it is preferably performed at temperatures of 100 to 150° C., particularly preferably at about 125° C.

The heterogeneously catalysed process according to the invention may be operated in a batchwise, semi-continuous or fully continuous mode.

The arginates preferably used in the process according to the invention, e.g. zinc arginate, can be compressed into, for example, pellets and placed in a tubular reactor. In accordance with another mode of operation, the powdered finely crystalline metal arginate is suspended in the fat or oil. After passage through a stirred tank cascade, the catalyst is filtered off or isolated using a centrifuge and reirculated.

The catalyst according to the invention can also be applied to a suitable support in order to improve the hydrodynamic conditions in a continuously operating reactor. In this manner, separation of the powdered catalyst from the product by filtration is not required. The support may be designed as cylinders or may have any other form beneficial to continuous operation of the reaction. High porosity is useful provided the dimensional stability of the heterogeneous catalyst does not suffer too much thereby.

In addition, the invention relates to fat and/or oil of biological origin which is prepared by the process explained above. This fat and/or oil according to the invention has a distribution of fatty acids different from that in the corresponding starting material and generally is also differentiated from the starting material by new material properties such as e.g. melting point or viscosity. The attached and only figure gives a graphical representation of the change in fatty acid distribution after transesterfication.

The process according to the invention is explained in more detail by means of examples in the following.

### EXAMPLE 1

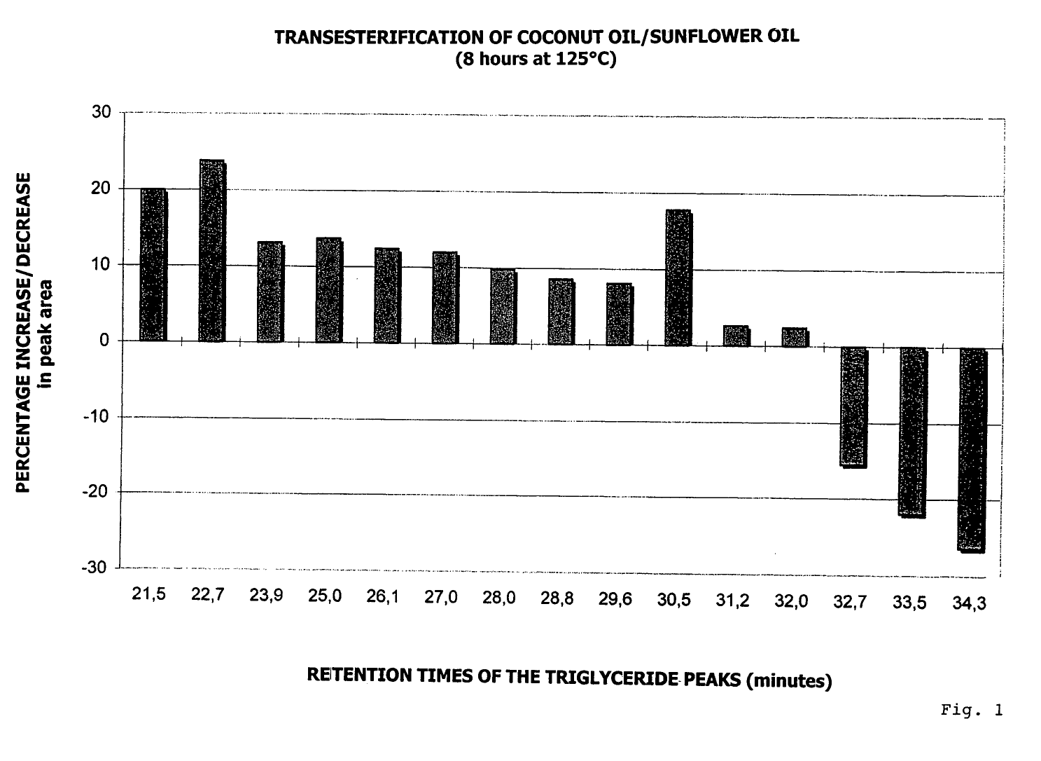

FIG. 1 shows, using an example of a mixture of sunflower oil and coconut oil in the ratio of 1:1, that a noticeable shift in the triglyceride spectrum is produced over the course of 8 hours at 125° C. in the presence of zinc arginate in powdered form (5 wt. %) as catalyst. The change in the peak area as a percentage is plotted against the retention time. The retention time of 32 minutes corresponded to tripalmitin, that of 34.3 minutes corresponded to tristearin and triolein. The peaks for tristearin and triolein overlap to a large extent.

### EXAMPLE 2

100 g of pig fat were mixed with 0.5 g of powdered zinc arginate at 125° C. and the mixture was stirred for about 3 hours. Then the catalyst was filtered off. The composition of the fat was tested using gas chromatography. Table 1 gives the composition of the fat before and after catalytic transesterification as a function of the retention time.

TABLE 1
Composition of the fats before and after transesterification as a
function of the retention time, as %-age of peak area

| Retention time (min) | Starting product (%) | Final product (%) |
|---|---|---|
| 27.2 | 0.42 | 1.02 |
| 30.3 | 0.26 | 0.41 |
| 31.2 | 0.96 | 0.82 |
| 32 | 4.04 | 3.7 |
| 32.3 | 0.14 | 0.5 |
| 32.8 | 22.93 | 2.8 |
| 33.6 | 50.94 | 73.2 |
| 33.8 | 3.21 | 1.28 |
| 34.1 | 16.37 | 15.36 |
| 34.7 | 0.74 | 0.86 |

The retention time of 32.0 minutes corresponded to the component tripalmitin, that of 34.1 minutes to the component tristearin. The softening point of the fat had been increased to a very small extent, by about 1° C.

1-9. (cancelled)

10. A process for preparing fat and/or oil with a modified distribution of fatty acids in the glycerides by heterogeneously catalysed transesterification, comprising reaction of the fat and/or oil of biological origin to be transesterified in the presence of a catalyst which contains a metal salt of a basic amino acid or an amino acid derivative.

11. The process according to claim 10, wherein the metal component of the catalyst is selected from the group consisting of calcium, strontium, barium, another alkaline earth metal and a heavy metal, and said heavy metal selected from the group consisting of silver, copper, zinc, manganese, iron, nickel, cobalt, lanthanum or another rare earth metal.

12. The process according to claim 10, wherein a quaternary nitrogen or a guanidino group is used as the amino acid component of the catalyst.

13. The process according to claim 10, wherein zinc or lanthanum salt of arginine is used as a catalyst.

14. The process according to claim 10, wherein zinc or lanthanum salt of carnitine is used as a catalyst.

15. The process according to claim 10, wherein the catalyst is applied to a support.

16. The process according to claim 10, wherein the transesterification is performed at temperatures in the range of 60 to 200° C.

17. The process according to claim 10, wherein the transesterification is performed at temperatures in the range of 100 to 150° C.

18. The process according to claim 10, wherein the amount of catalyst is 5 to 25 wt. %.

19. The process according to claim 10, wherein the amount of catalyst is 10 to 20 wt. %.

20. A fat and/or oil prepared by a process in accordance with claim 10.
